(19) United States
(12) Patent Application Publication
(10) Pub. No.: US 2005/0276623 A1
(43) Pub. Date: Dec. 15, 2005

(54) Image forming apparatus and cartridge

(75) Inventors: Jun Suzuki, Numazu-shi (JP); Masahiro Shibata, Numazu-shi (JP); Takeshi Kawamura, Sunto-gun (JP); Bunro Noguchi, Mishima-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/148,359

(22) Filed: Jun. 9, 2005

(30) Foreign Application Priority Data
Jun. 15, 2004 (JP) 2004-177546

(51) Int. Cl. G03G 15/08

(52) U.S. Cl. 399/55; 399/285

(57) ABSTRACT

An image forming apparatus having a developer carrying member for developing an electrostatic image formed on an image bearing member with a developer, and a flight developer carrying member provided between the image bearing member and the developer carrying member for regulating an area in which the developer flies from the developer carrying member to the image bearing member, wherein a voltage applied to the developer carrying member is controlled in accordance with information regarding the front edge location of the flight developer regulating member.

### BACKGROUND OF THE INVENTION

1Field of the Invention

The invention relates to an image forming apparatus in which an electrostatic image formed on an image bearing member is developed with a developer, and a cartridge, and as the image forming apparatus, use is preferably made, for example, of one of an electrostatic recording type or an electrophotographic type.

2. Related Background Art

In an image forming apparatus provided with the function of forming an image on a recording medium, such as, for example, a copying machine, a printer or a facsimile apparatus, there has heretofore been performed the developing operation of visualizing an electrostatic latent image formed on an image bearing member as a developer image (toner image) by a developing apparatus by the use of a developer.

As a developing apparatus by which such development is effected, there has been proposed and put into practical use, for example a dry type mono-component contact developing apparatus. Often in this case, a developer carrying member carrying a developer thereon and rotated like a rotated electrostatic latent image bearing member is pressed against or brought into contact with the image bearing member with a suitable relative peripheral speed difference to thereby develop an electrostatic latent image. In addition, in this case, the developing apparatus has many advantages such as the unnecessariness of a magnetic material as a developer, the ease of the simplification and downsizing of the apparatus, and the use of a nonmagnetic toner which leads to the applicability of the developing apparatus to a full-color image forming apparatus.

A conventional image forming apparatus 100 using a popular nonmagnetic mono-component developing process will now be described with reference to FIG. 13 of the accompanying drawings.

An electrophotographic photosensitive member (hereinafter referred to as the “photosensitive drum”) 101 as an image bearing member generally forms with a photoconductive layer applied to the surface of a cylinder is uniformly changed by a primary charger 102. Next, corresponding to image information inputted from an external device, light is applied from an exposing apparatus 103 to the surface of the photosensitive drum 101 to thereby form an electrostatic latent image thereon. In the case of a reversal developing process, the electrostatic latent image on the photosensitive drum 101 is made into a visible image, i.e., a developer image, in a developing apparatus 104, by a developer T having the same tribocharging polarity as an applied voltage to the primary charger 102.

The developer image is transferred to a transfer material Q by a transfer charger 105. The transfer material Q is separated from the photosensitive drum 101, and is subsequently conveyed to a fixing apparatus 106, whereby the developer image on the transfer material Q is fixed. Also, a developer T not transferred by the transfer charger 105, but residual on the photosensitive drum 101 is removed by a cleaning apparatus 107.

Here, the developer T contained in the developing apparatus 104 which executes the developing operation in the image forming apparatus 100 shown in FIG. 13 is a nonmagnetic mono-component developer of negative chargeability containing a pigment of any one color of yellow, magenta, cyan and black. A developing container 104c which constitutes the developing apparatus 104 and in which the developer T is contained is divided into a portion provided with a developing roller 104b which is a developer carrying member for executing the developing operation and a portion provided with agitating members 104a for agitating the developer, by a partition plate 104d. As the agitating members 104a, two agitating members 104a each of which is constituted by a plate worked into one of various shapes or a screw or the like exist for rotation in the direction indicated by the arrow F in FIG. 13, and convey the developer T to the developing roller 104b as the developer carrying member provided in the opening portion of the developing apparatus 104 which is opposed to the photosensitive drum 101, beyond the height of the partition wall 104d, by overflow. The number of the agitating members 104a is not limited to two, and the construction of the agitating members 104a can convey the developer T from the interior of the developing container 104c to the vicinity of the developing roller 104b, and is suitably changed in accordance with various constructions of the developing device. The partition plate 104d has its height made proper so as to be capable of always supplying a constant amount of developer to a developer supplying roller 104e disposed in contact with the developing roller 104b.

The developer supplying roller 104e is rotated in a counter direction relative to the developing roller 104b in the nip portion thereof with the developing roller 104b, and plays the role of supplying the developer T onto the developing roller 104b and also, stripping off the developer T on the developing roller 104b which has not been used for development even if it has passed a location opposed to the photosensitive drum 101, i.e., a developing area.

A regulating blade 104f as a developer amount regulating member abuts against the developing roller 104b, and regulates the developer T on the developing roller 104b to thereby form a thin developer layer. The developer amount T conveyed to the aforementioned developing area is determined by the abutting pressure or abutting length or the like of the regulating blade 104f which contacts with the developing roller 104b.

Further, as oscillating voltage is applied to the developing roller 104b, whereby an alternating electric field is formed between the photosensitive drum 101 and the developing roller 104b which are disposed at a predetermined gap.

The developer T conveyed to the developing area effects reciprocal motion between the surface of the developing roller 104b and the surface of the photosensitive drum 101, and part thereof adheres the electrostatic latent image formed on the surface of the photosensitive drum 101, whereby development is effected.

However, in such image forming apparatus and developing apparatus as described above in which a developing bias including an oscillating voltage is applied to between the developer carrying member and the image bearing member to thereby perform the developing operation, there may occur faulty development (image) called the “sweeping-together,” in which when development is effected, much developer gathers on the trailing end portion of a developer image formed in the developing area and the density of that region becomes high as compared with that of the other regions.

The “sweeping-together” is considered to occur due to a mechanism which will hereinafter be described.

FIG. 14 of the accompanying drawings is a typical view showing electric lines of force H formed in the gap “d” between the developing roller 104b and the photosensitive drum 101 to which an oscillating voltage comprising an AC voltage and a DC voltage superimposed one upon the other has been applied. The area in which these electric lines of force H act substantially corresponds to an area acting on the development of the electrostatic latent image on the photosensitive drum 101, i.e., the developing area α.

Here, the developing roller 104b and the photosensitive drum 101 are rotated in formed directions relative to each other, and these rotation directions in the gap “d” are the same, and when rotation is effected upstream and downstream with respect to these rotation directions, the same direction is indicated relative to the rotation directions of both of the developing roller 104b and the photosensitive drum 101.

As shown in FIG. 14, the electric lines of force H are formed substantially straight in the central portion (a) of the gap “d” between the developing roller 104b and the photosensitive drum 101, i.e., the region in which the developing roller 104b and the photosensitive drum 101 are most proximate to each other.

On the other hand, the electric lines of force H are formed in a curved shape in the opposite sides of the central portion (a), i.e., regions (b) and (c) in which the distance between the developing roller 104b and the photosensitive drum 101 is wide.

In a case where an electrostatic latent image Rb exists on the surface of the photosensitive drum 101 opposed to the developing roller 104b subjected to such electrical action, as shown in FIG. 15 of the accompanying drawings, the developer T is moved in the gap “d” between the developing roller 104b and the photosensitive drum 101 by the acting force of an electric field formed in an upstream side end portion (b) with respect to the rotation directions of the developing roller 104b and the photosensitive drum 101.

The state of this moved developer T will now be described with reference to FIG. 16 of the accompanying drawings. The developer T has a vector velocity V1 at a point a1 on a curved electric line of force H1 formed in the upstream side end portion (b) with respect to the rotation directions of the developing roller 104b and the photosensitive drum 101, in the tangential direction thereof, and is further moved to a point a2 on an outer curve H2.

Subsequently, at a point of time whereat the developer T has arrived at the point a2, the developer T is given a vector velocity V2 in the tangential direction of the electric line of force H2 at the point a2.

Thereupon, the developer T temporarily flies from the point a2 in the direction of a combined vector (V1+V2).

That is, in the upstream side end portion (b) with respect to the rotation directions of the developing roller 104b and the photosensitive drum 101, the developer T carried on the developer roller 104b, as shown in FIG. 15, repeats reciprocal motion along the electric lines of force H as indicated by a flight locus Q1 gradually going outwardly between the photosensitive drum 101 and the developing roller 104b.

Then, when as shown in FIG. 17 of the accompanying drawings, the boundary portion Rc between a non-image portion Ra (the surface potential thereof being −600 V) on the photosensitive drum 101 on which the electrostatic latent image is not formed and an electrostatic latent image Rb (the surface potential thereof being −100 V) continuedly formed on the upstream side reaches the upstream side end portion (b) with respect to the rotation directions of the developing roller 104b and the photosensitive drum 101 in which the electric lines of force are formed in a curved shape, the developer T on the developing roller 104b which exists downstream of the electrostatic latent image Rb flies as indicated by a flight locus Q2, and moves toward the side opposed to the electrostatic latent image Rb. Consequently, the developer T concentrates in the boundary portion Rc, and this developer T is again returned to the upstream side of the developing roller 104b and therefore, a large pool S of developer T is formed on this region of the developing roller 104b.

Also, when as shown in FIG. 18 of the accompanying drawings, the electrostatic latent image Rb becomes located in the upstream side end portion (b) with respect to the rotation directions of the developing roller 104b and the photosensitive drum 101, the developer T on the developing roller 104b repeats reciprocal motion gradually going outwardly between the developing roller 104b and the photosensitive drum 101 as indicate by a flight locus Q3. Consequently, in spite of the developing roller 104b being rotated, a large pool S of developer T continues to be formed at a predetermined location on the developing roller 104b on the upstream side thereof.

Further, when as shown in FIG. 19 of the accompanying drawings, by the rotation of the photosensitive drum 101, the boundary portion Re between the electrostatic latent image Rb and a non-image portion Rd connecting to the upstream side thereof reaches the upstream side end portion (b) with respect to the rotation directions of the developing roller 104b and the photosensitive drum 101, the electric field concentrates in the boundary portion Re, and the developer T of the large pool S of developer T formed on the developing roller 104b is drawn toward the boundary portion Re. Consequently, the developer T of the developer pool S is moved to the downstream side with the movement of the boundary portion Re while being reciprocally moved between the developing roller 104b and the photosensitive drum 101 as indicated by a flight locus Q4, and passes through the gap “d” between the developing roller 104b and the photosensitive drum 101.

Thereafter, as shown in FIG. 20 of the accompanying drawings, in the downstream side end portion (c) with respect to the rotation directions of the developing roller 104b and the photosensitive drum 101, the developer T of the large pool S of developer T adheres to the trailing end of the electrostatic latent image Rb, as indicated by a flight locus Q5, whereby a “sweeping-together” image is formed. As will be seen from the foregoing description, the “sweeping-together” image is liable to occur particularly on the trailing end portion of a solid image (a maximum density image).

In order to improve the above-described “sweeping-together”, there has been proposed a developing apparatus in which a plate-shaped electrode member having electrical conductivity is provided between the photosensitive drum 101 which is an image bearing member and the developing roller 104b which is a developer carrying member (see Japanese Patent No. 3366968).

In Japanese Patent No. 3366968, however, the addition of a power source and contacts and the like for applying a bias to this electrode member becomes necessary, and the application thereof to a compact developing device and a compact image forming apparatus carrying the developing apparatus therein.

On the other hand, there has also been proposed means for improving the above-described “sweeping-together” by setting a developing bias to be applied to the developing roller 104b which is a developer carrying member to a predetermined condition (see Japanese Patent No. 2971713).

In Japanese Patent No. 2971713, the reciprocal motion of the developer T not only in the upstream area (b) but also the downstream area (c) of the developing area is restrained. In a case where with the downsizing of the developing device and the image forming apparatus, use is made of a developing roller 104b and a photosensitive drum 101 having smaller diameters, the curvatures of these members become great and the developing area α (i.e., a range in which the distance between the members is short and the developer T is reciprocally moved) becomes narrow and therefore, if the reciprocal motion of the developer T in the downstream side end portion (c) is restrained as previously described, sufficient developing density will become difficult to obtain.

### SUMMARY OF THE INVENTION

It is an object of the present invention to provide an image forming apparatus and a cartridge in which the phenomenon of the density of the trailing end of an image becoming high is restrained.

It is another object of the present invention to provide an image forming apparatus and a cartridge in which the phenomenon of the “sweeping-together” of an image occurring during development is restrained.

It is another object of the present invention to provide an image forming apparatus and a cartridge in which a reduction in developing density is restrained from being caused.

It is another object of the present invention to provide an image forming apparatus and a cartridge which can obtain developer images of high dignity for a long period.

Further objects and features of the present invention will become apparent from the following detailed description when read with reference to the accompanying drawings.

### BRIEF DESCRIPTION OF THE DRAWINGS

FIG. 1 schematically shows the construction of an embodiment of a developing apparatus according to the present invention.

FIG. 2A shows an example of the sheet member mounting portion of the developing apparatus according to the present invention, and FIG. 2B is a fragmentary enlarged view thereof.

FIG. 3 schematically shows the construction of an example of an apparatus for operating the developing apparatus according to the present invention.

FIG. 4 shows an example of an oscillating voltage waveform according to the present invention.

FIG. 5 shows another example of the oscillating voltage waveform according to the present invention.

FIG. 6 schematically shows the construction of an embodiment of an image forming apparatus according to the present invention.

FIG. 7 is a block diagram showing an example of the controlling means of the image forming apparatus according to the present invention.

FIG. 8 is a flow chart showing an example of the oscillating voltage switching control operation according to the present invention.

FIG. 9 schematically shows the construction of an embodiment of a cartridge according to the present invention.

FIG. 10 schematically shows the construction of another embodiment of the image forming apparatus according to the present invention.

FIG. 11 is a block diagram showing another example of the controlling means of the image forming apparatus according to the present invention.

FIG. 12 is a flow chart showing another example of the oscillating voltage switching control operation according to the present invention.

FIG. 13 schematically shows the construction of an example of a conventional image forming apparatus.

FIG. 14 is an illustration showing the state of electric lines of force between an image bearing member and a developer carrying member.

FIG. 15 is an illustration showing the state of the sweeping-together between the image bearing member and. the developer carrying member.

FIG. 16 is an illustration showing the state of the sweeping-together between the image bearing member and the developer carrying member.

FIG. 17 is an illustration showing the state of the sweeping-together between the image bearing member and the developer carrying member.

FIG. 18 is an illustration showing the state of the sweeping-together between the image bearing member and the developer carrying member.

FIG. 19 is an illustration showing the state of the sweeping-together between the image bearing member and the developer carrying member.

FIG. 20 is an illustration showing the state of the sweeping-together between the image bearing member and the developer carrying member.

### DESCRIPTION OF THE PREFERRED EMBODIMENTS

A developing apparatus and a cartridge according to the present invention will hereinafter be described in greater detail with reference to the drawings. The present invention is applied to a developing apparatus described in Embodiment 1 or 2 and an image forming apparatus provided with the same described in Embodiment 3, and an image forming apparatus and a cartridge described in Embodiment 4.

Embodiment 1

In this embodiment, it is to be understood that the present invention is applied to a developing apparatus 1 provided in image forming apparatuses or cartridges of various constructions which carry out an image forming process including a developing step.

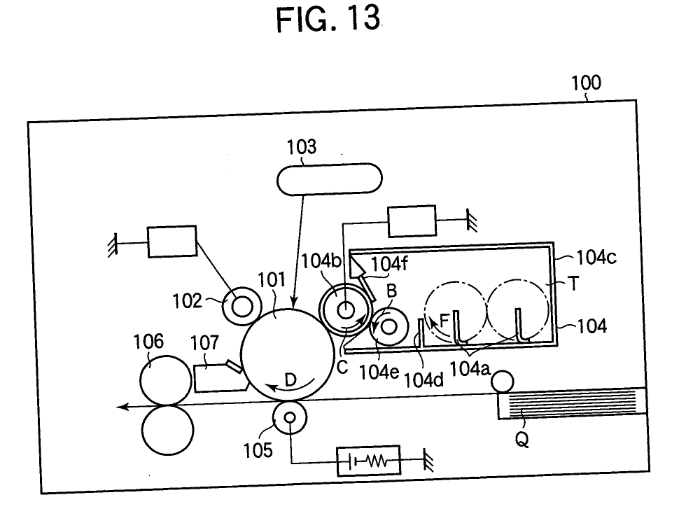

The developing apparatus 1 described in the present embodiment is applied when the developing step is carried out, for example, in the image forming apparatus of such a construction as shown in FIG. 13 described in the conventional example, and such image forming apparatuses of various constructions as will be described later in Embodiments 3 and 4.

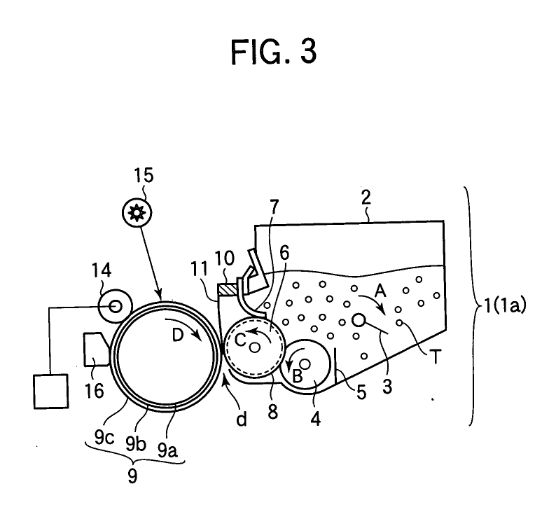

For example, as the most basic construction, the developing apparatus 1 according to the present embodiment is used in such an apparatus as shown in FIG. 3. In this apparatus, as an image bearing member 9, use is made of an organic photosensitive drum comprising an aluminum substrate 9a having an outer diameter of 30 mm, a charge generating layer 9b formed thereon, and a charge transporting layer 9c formed on the upper layer thereof.

Around the image bearing member 9, there are provided a roller charging device 14 for charging the surface of the image bearing member 9 to uniform potential, and a light source 15 for exposure turned on and off at predetermined intervals in synchronism with the rotation of the image bearing member 9. The image bearing member 9 is charged by the charging device 14, and thereafter is exposed to light by the light source 15 for exposure, whereby an electrostatic latent image is formed on the image bearing member.

A non-contact developing device (developing device) 1 as the developing apparatus according to the present embodiment is disposed downstream of the location of the light source 15 for exposure with respect to the rotation direction of the image bearing member 9. The developing device 1 is provided with a developer carrying member carrying a developer thereon, and the developer carried on this developer carrying member is provided in non-contact with the image bearing member 9 in a developing area. Also, in the image forming apparatus, there is provided a cleaning apparatus 16 for removing a developer residual on the image bearing member after the developer has been transferred from the image bearing member 9 to a transfer material. The developing device 1 develops the electrostatic latent image formed on the image bearing member 9 with the developer.

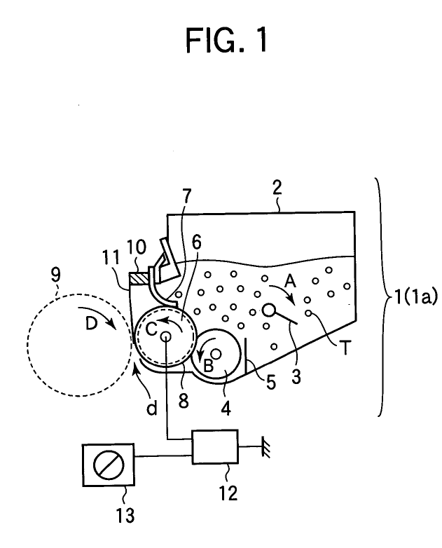

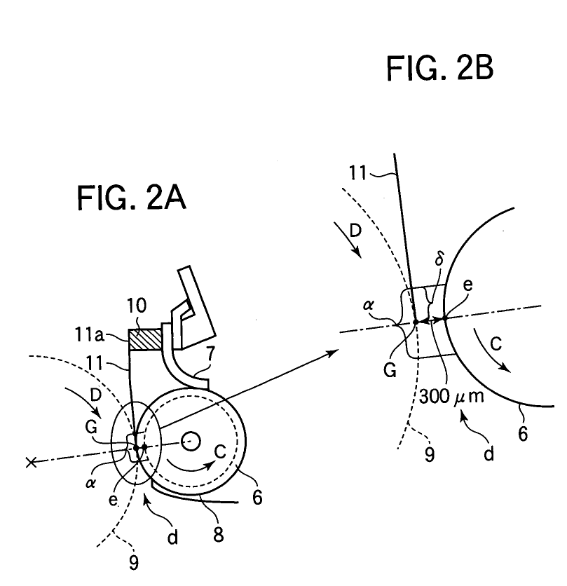

FIG. 1 is a typical view of the developing device 1 which is the present embodiment, FIG. 2A shows the sheet member mounting portion of this developing device 1, and FIG. 2B is an enlarged view of the vicinity of the developer carrying member.

The developing apparatus according to the present embodiment is the non-contact developing device 1 directed to use in an image forming apparatus of an electrophotographic type, and develops the electrostatic latent image formed on the image bearing member 9 such as, for example, a photosensitive drum by applying an oscillating voltage to between the developer carrying member 6 disposed at a predetermined gap from the image bearing member 9 and rotated in one direction and the image bearing member 9.

The construction of the non-contact developing device 1 will be described here with reference to FIG. 1.

A space in a frame member constituting the non-contact developing device 1 is utilized as a developer containing portion 2 for containing the developer T.

The developer T contained in the developer containing portion 2 is conveyed to a supplying roller 4 side by an agitating member 3 rotated in the direction indicated by the arrow A in FIG. 1. Since the developer containing portion 2 and the supplying roller 4 are partitioned by a partition plate 5, the developer T having passed over the partition plate 5 by the pressure of the agitating member 3 is conveyed to the supplying roller 4 in a substantially constant amount by overflow.

On the other hand, the supplying roller 4 is rotated in the direction indicated by the arrow B in FIG. 1 which is a counter direction to the rotation direction of a developing roller 6 which is the developer carrying member while being in contact with the developing roller 6, thereby charging the developer T and supplying it to the developing roller 6.

The developer T carried on the developing roller 6 rotated in the direction indicated by the arrow C is formed to a predetermined layer thickness by a developing blade 7 which is a developer layer thickness regulating member, and is subsequently conveyed to a developing area α for the image bearing member 9 which is a member to be developed indicated by broken line in FIG. 1. In the developing area α, the developing roller 6 and the image bearing member 9 are opposed to each other with a gap “d” interposed therebetween. Here, the developing roller 6 and the image bearing member 9 are rotated in a forward direction so as to be moved in the same direction in the opposed portion of the two.

The developer T conveyed to the gap “d” is reciprocally moved between the image bearing member 9 and the developing roller 6 by an oscillating voltage comprising an AC voltage and a DC voltage superimposed one upon the other and applied as a developing bias from a power source 12 for development to the developing roller 6. The developer T, during the behavior thereof, adheres to the electrostatic latent image formed on the surface of the image bearing member 9, whereby development is effected. The oscillating voltage as the developing bias is set to such a value as crosses both of the dark portion potential and light portion potential of the image bearing member are therefore, in both of the dark portion and light portion of the image bearing member 9, an alternating electric field is formed between the developing roller 6 and the image bearing member 9. That is, the DC voltage as the developing bias is set to between the dark portion potential and light portion potential of the image bearing member 9. This developing bias will be described later in detail.

Here, a developer T not transferred to the surface of the image bearing member 9 is collected again by the developing roller 6 for use for the next development.

As will be understood with reference to FIG. 2, at the opposite end portions of the developing roller 6, there are provided ring-shaped. regulating runners 8 contacting with the developing roller 6 by the inner diameter portions thereof, and having the outer diameter portions thereof abutting against the image bearing member 9 to thereby serve to keep the surface of the developing roller 6 and the surface of the image bearing member 9 at a predetermined gap.

In the non-contact developing device 1 according to the present embodiment, the developing roller 6 used is a sleeve-shaped member prepared by blending carbon or the like into a resin solution to thereby effect resistance adjustment, and thereafter effecting coating on an aluminum blank tube having an outer diameter of 15 mm.

It should be noted that adjustment was made so that the gap “d” between the surface of the developing roller 6 and the surface of the image bearing member 9 might be kept at 300 μm by the regulating runners 8.

Also, as the developer T, use is made of a negatively charged nonmagnetic mono-component toner, but it is possible to utilize a developer suitable for non-contact development, irrespective of being magnetic or nonmagnetic.

The construction of the developing device 1 is not restricted to that shown in FIG. 1, but may be such one having a plurality of agitating members as provided in the conventional image forming apparatus of FIG. 13.

In the present embodiment, a sheet member 11 formed of an insulating material is disposed so as to hang down from the upstream side with respect to the rotation direction C of the developing roller 6 and the rotation direction D of the image bearing member 9, and to enter the gap “d” formed by the image bearing member 9 and the developing roller 6, and the developing area α which is an area existing in the gap “d” and acting for development.

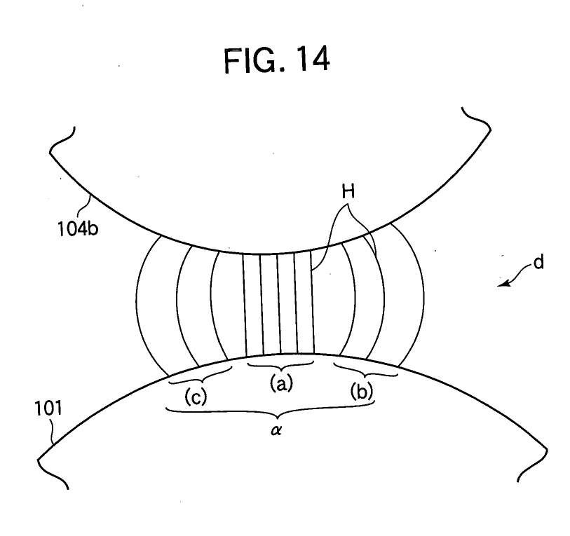

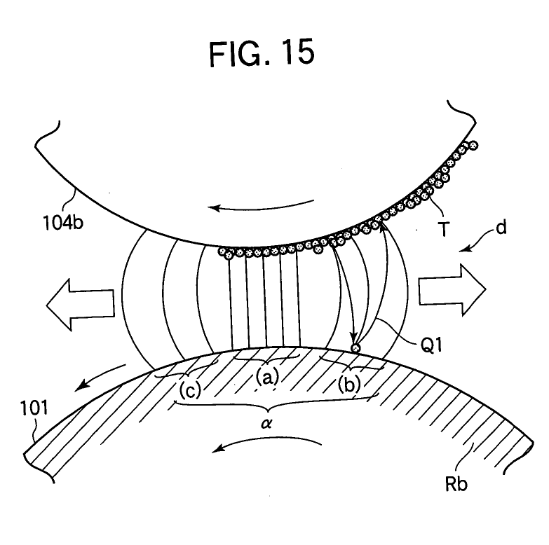

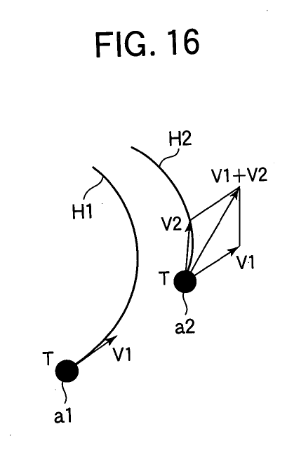

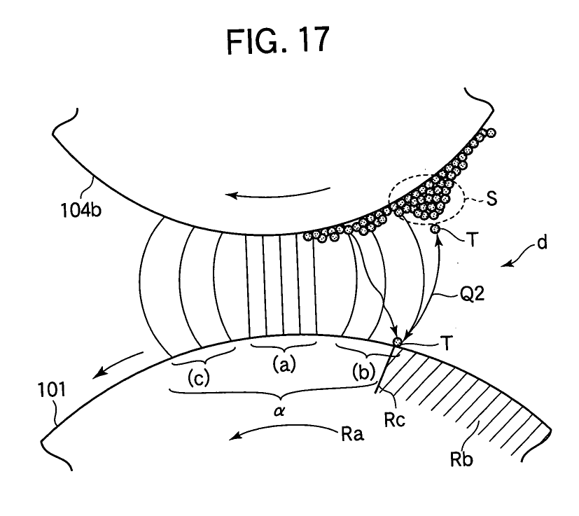

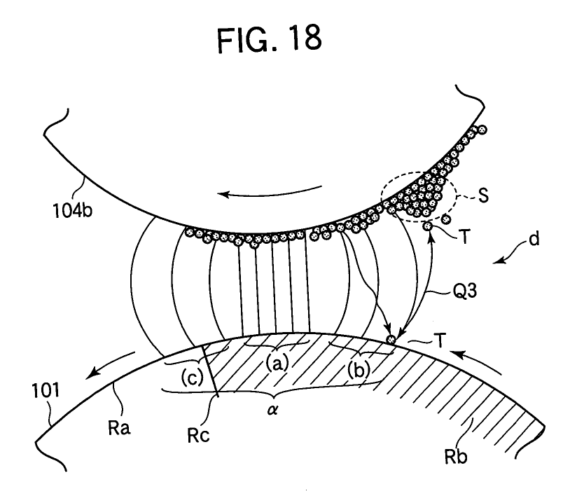

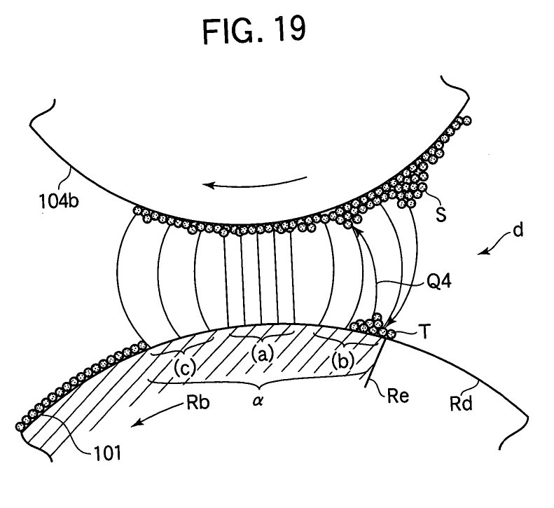

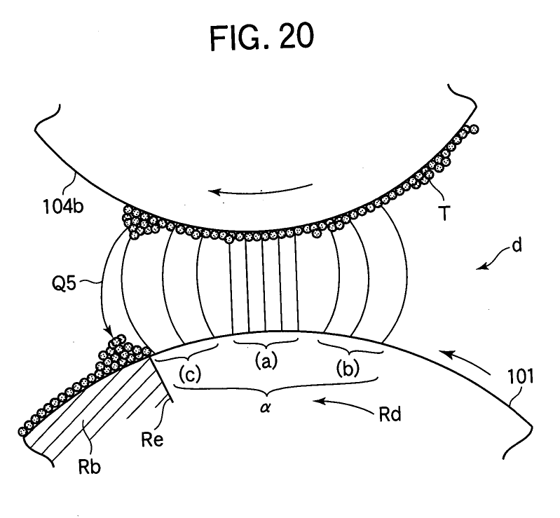

By providing such a sheet member 11, in FIGS. 14 to 20 used for the description of the principle of occurrence of the “sweeping-together” in the background art, the flight motion of the developer T reciprocally moved in the gap “d” formed by the developing roller 104b (developer carrying member) and the photosensitive drum 101 (image bearing member) shown therein at the upstream side end portion with respect to the rotation directions of the two members is blocked. Accordingly, the large pool S (FIG. 17) of developer T is not formed at a predetermined location upstream with respect to the rotation direction C of the developing roller 104b, and such a phenomenon as shown in FIG. 20 that a great deal of developer T adheres to the trailing end of the electrostatic latent image Rb on the surface of the image bearing member does not occur, in the downstream side end portion (c) with respect to the rotation directions of the developing roller 104b and the photosensitive drum 101, whereby the occurrence of the “sweeping-together” image is deterred.

That is, in the non-contact developing device 1 according to the present embodiment, as shown in FIG. 2, a pedestal 10 as a supporting member is fixed to the developing blade 7, and the sheet member of polyethylene terephthalate resin (PET sheet) 11 having a thickness of about 60 μm is attached to the pedestal 10. This attached portion 11a becomes the fixed end of the sheet 11.

In contrast with the fixed end 11a of the PET sheet 11, the free end G which is not fixed to the pedestal 10 enters the developing area α in the gap “d” between the developing roller 6 and the image bearing member 9, and is disposed so as to hang down from the pedestal 10.

In the present embodiment, the PET sheet 11 is mounted so as to hang down from above with respect to the acting direction of gravity and therefore, this state is expressed as “hang down”.

To cause the sheet member 11 to hang down, the fixed end 11a is disposed above with respect to the direction of gravity, and the free end G is disposed below. That is, the free end of the sheet member is provided below the supported portion of the sheet member in the vertical direction. In order to hang it down from the upstream side with respect to the rotation direction of the developing roller 6 into the gap “d” between the developing roller 6 and the image bearing member 9, it is preferable that the rotation directions of the developing roller 6 and the image bearing member 9 (which are the same direction because the two members are rotated in a forward direction) be the direction of gravity.

Here, the developing area α is such an area as described in the conventional example with reference to FIG. 14 in which the electric lines of force H are produced by the developing bias, i.e., an area which actually acts on development. It has been found that the developing area α in the present embodiment, when under the above-described condition of the developing bias, the outer diameter of the image bearing member 9 is 30 mm, has a range of 1.5 mm to 1.8 mm from the closest portion “e” of the image bearing member 9 and the developing roller 6 to each of the upstream and downstream sides with respect to the rotation direction of the developing roller 6, i.e., a range of the order of 3.0 to 3.6 mm from the closest portion “e”.

The sheet-like member such as the PET sheet 11 hanging down from upstream with respect to the rotation direction of the developing roller 6 is formed of an insulating material and therefore, does not accelerate the occurrence of a discharging phenomenon in the electric field formed in the gap “d” between the developing roller 6 and the image bearing member 9.

However, when the sheet member 11 excessively shields the developing area α in the gap “d” between the image bearing member 9 and the developing roller 6, whereby the amount of developer T intervening in the developing action is decreased, a region (streak) which is not developed like a blank longitudinal streak may occur or developing density may generally be reduced.

In the present embodiment, a power source 12 for development for applying a developing bias to the developing roller 6 in the above-described developing device 1 has connected thereto switching means 13 for the oscillating voltage applied as the developing bias to the developing roller 6, and it can be mentioned that the values of these can be suitably adjusted in accordance with an amount δ by which the PET sheet 11 shields the developing area α. That is, the developing bias can be controlled in accordance with the front edge location of the sheet 11.

Thereby, even when the amount of developer T intervening in the developing action is decreased, an optimum oscillating electric field can be formed so that the developer T may easily fly to the electrostatic latent image and therefore, the streak and a reduction in the developing density can be suppressed so that a stable quality of developed image can be obtained. That is, even if the front edge location of the sheet member 11 is located within a wide range in each individual developing apparatus, there can be obtained a good quality of developed image in which the “sweeping-together” is restrained.

As described above, in the developing device 1, the developer T conveyed to the developing area α by the developing roller 6 adheres to the electrostatic latent image formed on the surface of the image bearing member 9 while it is reciprocally moved between the image bearing member 9 and the developing roller 6 by the oscillating bias comprising an AC voltage and a DC voltage superimposed one upon the other applied from the power source 12 for development to the developing roller 6, whereby development is effected.

As regards the developing bias in the non-contact developing device 1 according to the present embodiment, a developing bias comprising a DC voltage Vdc=−300 V superimposed upon a rectangular AC bias of peak-to-peak voltage: 2.0 kVpp, a frequency: 2.5 kHz and duty: 50% was used as a reference bias.

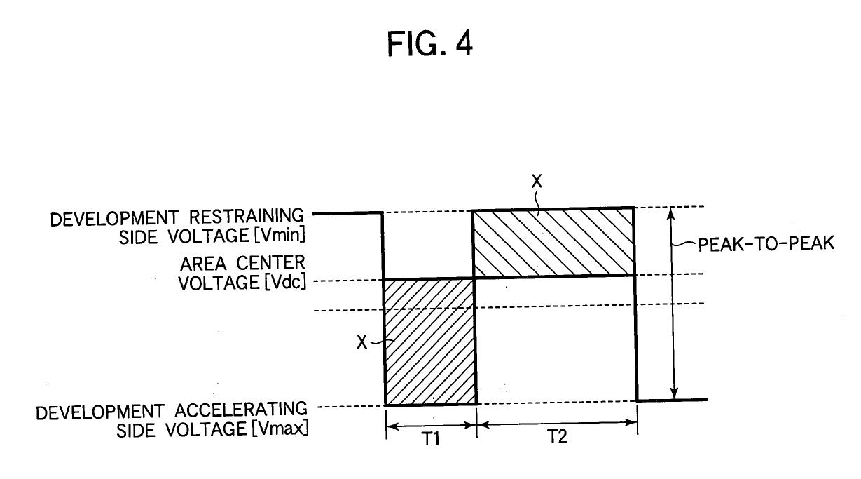

Describing the duty of the above-mentioned AC bias in detail, in such a rectangular AC bias as shown in FIG. 4, the maximum value of a development accelerating side voltage forming the opposite ends of the peak-to-peak voltage, i.e., a voltage provided with a condition for causing the developer T to fly to the surface of the image bearing member 9, is defined as Vmax, and the maximum value of a development restraining side voltage, i.e., a voltage provided with a condition for restraining the flight of the developer T to the surface of the image bearing member 9, is defined as Vmin. An area center voltage set so that the area X of a region surrounded by a straight locus indicative of the predetermined bias value between Vmax and Vmin and a locus indicative of a bias waveform with the AC bias may be equal on respective voltage sides is defined as Vdc. The rate (the unit of which is %) of a time T2 providing the development accelerating side voltage which is occupied in a rectangular AC bias period (T1+T2) to this Vdc is this duty. In FIG. 4, the dark portion potential (not shown) of the image bearing member 9 is set to between Vmax and Vdc, and the light portion potential (not shown) of the image bearing member 9 is set to between Vdc and Vmin. That is, an alternating electric field is formed both between the dark portion potential of the image bearing member and the developing bias and between the light portion potential of the image bearing member and the developing bias.

The amount by which the PET sheet 11 shields the developing area α, i.e., δ indicated in FIGS. 2A and 2B, was set, and about this setting, the location of the free end G of the PET sheet 11 was changed in the gap “d” (including the developing area α) to thereby examine the situations of “sweeping-together” and density reduction in the developer image formed on the image bearing member 9. Further, the setting of the oscillating bias as the reference bias shown in FIG. 4 which provides the AC bias of this developing bias was changed to thereby likewise examine the situations of “sweeping-together” and density reduction in the developer image formed on the image bearing member 9.

An apparatus used for the evaluation will hereinafter be described with reference to the aforedescribed typical view of FIG. 3.

As the image bearing member 9, there was prepared an organic photosensitive drum comprising an aluminum substrate 9a having an outer diameter 30 mm, a charge generating layer 9b formed thereon and a charge transporting layer 9c formed on the upper layer thereof, as described above.

Also, as in the image forming apparatus, around the image bearing member 9, there were mounted a roller charging device 14 for charging the surface of the image bearing member 9 to uniform potential, and a light source 15 for exposure turned on and off at predetermined interval in synchronism with the rotation of the image bearing member 9. A non-contact developing device 1 was disposed downstream of the location of the light source 15 for exposure with respect to the rotation direction of the image bearing member 9.

The image bearing member 9 is rotatively driven at 1 rpm and moreover, the light source 15 for exposure is repetitively turned on and off at intervals of 0.5 second. A developing roller 6 was rotatively driven at 3.2 rpm, and adjustment was effected so that the surface of the developing roller 6 might be moved with a speed difference of 150% relative to the surface of the image bearing member 9. As previously described, the developing roller 6 and the image bearing member 9 are normally rotated in forward directions relative to each other.

Light interception was sufficiently effected with the above-described entire apparatus covered, whereafter a bias value applied to the roller charging device 14 was adjusted to thereby charge the surface of the image bearing member 9 to −500 V, and exposure was effected by the light source 15 for exposure, whereupon the surface potential of the exposed portion of the image bearing member 9 lowered to −100 V.

Subsequently, the aforedescribed developing bias is applied to the developing roller 6 of the non-contact developing device 1 whereby the exposed portion is developed. At this point of time, judgment as to whether the “sweeping-together” has occurred to the trailing end portion of the exposed portion on the image bearing member 9 is visually effected.

In this evaluation, the set location of the free end G of a PET sheet 11 was adjusted at a pitch of 0.3 mm on each of the upstream and downstream sides with respect to the rotation direction of the developing roller 6 with the closest portion “e” of the image bearing member 9 and the developing roller 6 in such a three-dimensional measuring apparatus as shown in FIG. 3, i.e., the central portion of the developing area α, adopted as the reference. As a result of the measurement by the three-dimensional measuring apparatus, portions particularly requiring detailed conditioning were adjusted with the set position of the free end G cut at a pitch of 0.1 mm.

First, in order to confirm the superiority of the non-contact developing device 1 according to the present embodiment, evaluation was made about a case where the switching of the oscillating bias applied to the developing roller 6 is not effected in accordance with the amount δ by which the PET sheet 11 shields the developing area α.

The result of the above-described evaluation will now be described by the use of Table 1 below.

TABLE 1
Location of free end of PET sheet and Sweeping-together (without the switching of oscillating bias)

| | location of free end (mm) | | | | | | | | | | | | |
|---|---|---|---|---|---|---|---|---|---|---|---|---|---|
| | +1.2 | 0.9 | +0.6 | +0.3 | Reference | −0.3 | −0.6 | −0.9 | −1.2 | −1.5 | −1.6 | −1.7 | −1.8 |
| sweeping- | x | x | Δ | ∘ | ∘ | ∘ | ∘ | ∘ | ∘ | Δ | Δ | Δ | Δ |
| together | | | | | | | | | | | | | |
| density | x | x | x | Δ | ∘ | ∘ | ∘ | ∘ | ∘ | ∘ | ∘ | ∘ | ∘ |
| | | | (streak) | (streak) | | | | | | | | | |

∘ . . . No problem.
Δ . . . No problem in practical use, yet each phenomenon can be confirmed.
x . . . Problematic in practical use.
(streak) . . . A region not developed like a blank longitudinal streak occurred

In Table 1, the signs given to numerical values shown in the row of free end location are such that with the closest portion “e” of the image bearing member 9 and the developing roller 6 as the reference (0), the upstream side with respect to the rotation direction of the developing roller 6, i.e., the upper side with respect to the acting direction of gravity, because as previously described, the rotation directions of the developing roller 6 and the image bearing member 9 are the direction of gravity in the gap “d”, is represented by the negative, and the downstream side with respect to the rotation direction of the developing roller 6, i.e., the lower side with respect to the acting direction of gravity, is represented by the positive, and the numerical values represent the distance (mm) from the closest portion “e” in + or − direction. That is, when the amount δ by which the PET sheet 11 shields the developing area α is great, the numerical values in the row of free end location become positive, and when the amount δ by which PET sheet 11 shields the developing area α is small the numerical values in the row of the location of the free end become negative.

As will be seen from the result shown in Table 1, the “sweeping-together” is improved when the free end G of the PET sheet 11 is at a location of −1.8 mm to +0.6 mm.

This is considered to be because on the upstream side (i.e., the upstream side with respect to the acting direction of gravity) in the gap “d” formed by the image bearing member 9 and the developing roller 6, the amount of developer T acting on development is limited by the PET sheet 11, whereby the amount of developer T flying concentrically to the trailing end of the electrostatic latent image on the image bearing member 9 is decreased.

When the location of the free end was −2.1 mm, it was confirmed that the deterring effect for the “sweeping-together” is not obtained, and the free end G of the PET sheet 11 is located outside the aforedescribed developing area α.

From the above-described result, it has been found that it is possible to restrain the “sweeping-together” by setting the range within which the PET sheet 11 shields the developing area α to the upstream end side to the central portion of the developing area α in the rotation direction of the developing roller 6.

On the other hand, when the free end G of the PET sheet 11 was at a distance of +0.3 mm, a region not developed like a blank longitudinal streak was observed, and when the free end G was at a distance of +0.6 mm or greater, an apparent reduction in developing density was observed.

The above-described phenomenon is considered to occur because the PET sheet 11 excessively shields the developing area α in the gap “d” between the image bearing member 9 and the developing roller 6, whereby the amount of developer T intervening in the developing action is extremely decreased.

So, the result of evaluation when the switching of the oscillating bias applied to the developing roller 6 was effected by the use of a similar apparatus will hereinafter be described by the use of Table 2 below.

The duty values of the oscillating bias shown in Table 2 were selected so that the “sweeping-together” might be restrained to the maximum in accordance with the amount δ by which the PET sheet 511 shields the developing area α and sufficient developing density might be obtained.

TABLE 2
Location of free end of PET sheet and Sweeping-together (with the switching of oscillating bias)

| | location free end (mm) | | | | | | | | | | | | |
|---|---|---|---|---|---|---|---|---|---|---|---|---|---|
| | +1.2 | +0.9 | +0.6 | +0.3 | reference | −0.3 | −0.6 | −0.9 | −1.2 | −1.5 | −1.6 | −1.7 | −1.8 |
| duty (%) | 60 | 60 | 55 | 55 | 50 | 50 | 50 | 50 | 45 | 40 | 35 | 30 | 30 |
| sweeping- | x | Δ | ∘ | ∘ | ∘ | ∘ | ∘ | ∘ | ∘ | ∘ | ∘ | Δ | Δ |
| together | | | | | | | | | | | | | |
| density | x | x | Δ | ∘ | ∘ | ∘ | ∘ | ∘ | ∘ | ∘ | ∘ | ∘ | ∘ |
| | | | (streak) | | | | | | | | | | |

∘ . . . No problem.
Δ . . . No problem in practical use, yet each phenomenon can be confirmed.
x . . . Problematic in practical use.
(streak) . . . A region not developed like a blank longitudinal streak occurred

As will be seen from the result shown in Table 2, when the free end G of the PET sheet 11 was at a location of −1.8 mm to +0.6 mm, the “sweeping-together” was improved to a problem-free level, and an improved effect was also seen when the free end G further entered the developing area α.

On the other hand, when the free end G of the PET sheet 11 was at a location of +0.6 mm, a region not developed like a blank longitudinal streak could be observed, and when the PET sheet 11 was at a location of +0.9 mm or greater, an apparent reduction in developing density could be observed.

As described above, by the switching of the oscillating bias applied to the developing roller 6 being effected in accordance with the amount δ by which the PET sheet 11 shields the developing area α, a good quality of developed image could be obtained in a wider area, as compared with the case shown in Table 1 where the switching is not effected. It is preferable that the amount δ be stored in the image forming apparatus as information regarding the front edge location of the sheet 11, and it is preferable that the amount δ be stored in the apparatus or a cartridge by such a method as shown, for example, Embodiments 3 and 4 which will be described later.

While in the non-contact developing device 1 according to the present embodiment, the PET sheet 11 is used as a sheet-like member mounted on the pedestal, a similar effect will be obtained by any material which has insulativeness, for example, like urethane, and which will not injure a member to be developed when it contacts with the latter (for example, polypropylene, acril resin or the like molded into a sheet shape).

The width of the PET sheet 11 in the axial direction of the developing roller 6 is designed to cover all of the area in which the developing roller 6 carries the developer T thereon (the developing width) and not to extend beyond the regulating runners 8 provided on the opposite end portions of the developing roller, whereby the “sweeping-together” can be restrained at least over the entire developing width. Accordingly, it is preferable that in the longitudinal direction of the developing roller 6, the width of the sheet 11 be made greater than the developing width and smaller than the distance between the regulating runners 8.

Also, if as in the non-contact developing device 1 according to the present embodiment, the PET sheet 11 is hung down and disposed in the gap between the image bearing member 9 and the developing roller 6, it will also be possible to restrain the “sweeping-together” in a tandem type or rotary type multi-color image forming apparatus which houses a plurality of non-contact developing devices 1 therein and which layers developer images subjected to development in the respective developing devices to thereby effect the formation of a full-color image.

Also, as in the non-contact developing device 1 according to the present embodiment, the duty of the oscillating bias was adjusted to thereby effect the control of a developing property. Besides, the peak-to-peak voltage and frequency in the AC component constituting the oscillating bias, and the DC voltage value superimposed on the aforedescribed AC component are set in accordance with the amount δ by which the PET sheet 11 shields the developing area α, whereby a similar effect can be obtained.

Thus, in the developing apparatus, a sheet member of an insulating material is installed so as to hang in the developing area in the gap formed by the image bearing member and the developing carrying member, and provision is made of means for changing the oscillating bias applied to the developer carrying member which forms an oscillating electric field, whereby in the developing area formed by the developer carrying member and the image bearing member, the flight motion of the developing reciprocally moved in the upstream side end portion with respect to the rotation directions of the two members is blocked, and a large pool of developer is not formed at a predetermined location on the developer carrying member on the upstream side thereof with respect to the rotation direction thereof, and in the downstream side end portion with respect to the rotation directions of the developer carrying member and the image bearing member, it is avoided for a great deal of developer to adhere to the trailing end of the electrostatic latent image on the surface of the image bearing member, whereby the occurrence of a “sweeping-together” image is deterred.

Further, even when there occurs a decrease in the amount of developer intervening in the developing action due to the sheet member excessively shielding the developing area in the gap between the image bearing member and the developer carrying member, an optimum oscillating electric field can be formed so that the developer may easily fly to the electrostatic latent image and therefore, the occurrence of a region not developed like a blank longitudinal streak and a general reduction in the developing density can be restrained so that a stable quality of developed image may be obtained. Moreover, even if the front edge location of the sheet member is located over a wide range, there can be obtained a good quality of developed image in which the “sweeping-together” is retrained.

Also, if the sheet member is disposed in contact with the image bearing member, it will become possible to easily set the front edge location of the sheet member formed of an insulating material in the minute gap between the developer carrying member and the image bearing member. Consequently, it will become easy to provide the accuracy of the front edge location of the sheet member. In addition, by the sheet member being positively pressed against the image bearing member with a predetermined pressure force, the inclination of the sheet member toward the developer carrying member side can be restrained to thereby space the sheet member apart from the layer of the developer carried on the developer carrying member. By this method, a faulty image such as uneven density can be prevented from occurring, without the sheet member contacting with the surface of the developer carrying member to thereby disturb the developer coat layer on the developer carrying member.

Although the method of mounting the sheet member is not particularly restricted, the sheet member formed of an insulating material can be attached to a supporting member mounted on the regulating member (developing blade) or a developing apparatus frame member holding the regulating member (developing blade), and can be simply installed in the gap between the developer carrying member and the image bearing member by a simple construction and thus, the simplification of the developing apparatus mechanism can be achieved. Also, together with the interchange of the developing apparatus, the interchange of the sheet member formed of an insulating material can also be effected and therefore, when the sheet member is damaged or the effect thereof is reduced by the contamination or the like by the developer, maintenance can be done easily.

Embodiment 2

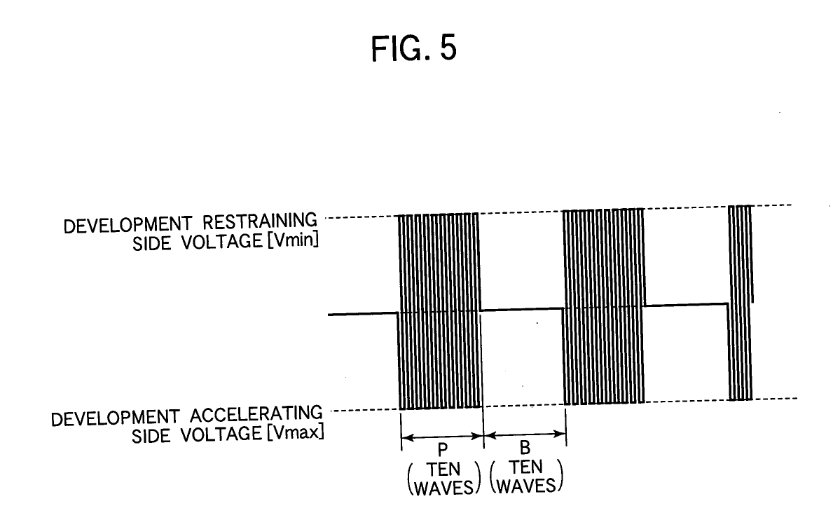

This embodiment is characterized in that while in Embodiment 1, the duty of the AC component is changed by the oscillating bias as a developing bias having an AC component of such a waveform as shown in FIG. 4, in a developing apparatus la, such an oscillating bias as shown in FIG. 5 called a blank pulse bias in which a portion (pulse portion) in which potential changes alternately and a portion (blank portion) in which potential does not change but becomes constant occur alternately is applied as the AC component, and the ratio of the portion in which potential changes alternately and the portion in which potential does not change but becomes constant to this blank pulse bias is adjusted in accordance with the amount δ by which the PET sheet 11 shields the developing area α.

The sweeping-together image, as described above, is caused by the reciprocal motion of the toner between the image bearing member 9 and the developing roller 6. Consequently, the greater is the frequency of the reciprocal motion of the toner, the more liable to be aggravated is the sweeping-together. It is because of this that the sweeping-together image is move aggravated as the rotation speed of the image bearing member 9 is lowered. Generally, the toner which is the developer gains a force during the switching of the polarity of the developing bias and flies in the direction toward the image bearing member or the direction toward the developing roller. The blank pulse is decreased in the frequency of the switching of the polarity thereof and therefore, restrains the reciprocal motion of the toner. Thereby, it becomes possible to reduce the sweeping-together image.

Further, the amount by which the reciprocal motion of the toner is restrained can be controlled by the amplitude rate or the like of the blank pulse. The amplitude rate is P/(P+B)×100% when the time of the amplitude portion (pulse portion) of the blank pulse is defined as P, and the time of the blank portion thereof is defined as B. When the amplitude rate is raised, the amount of reciprocal movement of the toner is increased and the sweeping-together and image density are increased. Also, when the amplitude rate is lowered, the reciprocal motion of the toner is restrained and the sweeping-together and image density are decreased.

In other words, the developer T generally receives an acting force at the polarity switching timing of the oscillating voltage applied to the developing roller 6, and flies in the direction toward the image bearing member 9 or the direction toward-the developing roller 6. A blank pulse bias is used as the developing bias and a portion (blank portion) in which an oscillating electric field is not formed is provided in the oscillating voltage, thereby decreasing the frequency of the switching of the polarity, and restraining the reciprocal motion of the developer T between the image bearing member 9 and the developing roller 6. Consequently, it becomes possible to reduce the “sweeping-together” effectively together with the aid of the sheet member 11.

Further, even when the sheet member 11 excessively shields the developing area α, the portion in the aforedescribed oscillating voltage in which the oscillating electric field is not formed is decreased, whereby the reciprocal motion of the developer T between the image bearing member 9 and the developing roller 6 can be accelerated to thereby obtain optimum developing density.

The developing apparatus 1a used in the present embodiment adopts a construction similar to that of the developing apparatus 1 described in Embodiment 1, except for the condition of the above-described oscillating bias and therefore, need not be described in detail.

The blank pulse bias as the AC component of the developing bias applied to the developing roller 6 in the present embodiment will hereinafter be described with reference to FIG. 5.

In the present embodiment, the oscillating bias applied to the developing roller 6 is formed by a pulse waveform portion P in which potential changes alternately by an amount corresponding to ten waves, and a blank portion B in which potential does not change during a similar period (corresponding to ten waves) but becomes constant potential. Such an oscillating bias will hereinafter be shown as “10/10BP (blank pulse of pulse portion 10 waves/blank portion 10 waves)”.

Also, the frequency of the pulse portion in which the potential changes alternately is 3.0 kHz, the peak-to-peak voltage (amplitude) thereof is 2.0 kV and the duty thereof is 50%, and the peak-to-peak center value of the pulse waveform portion P was set to −300 V. That is, here the duty is 50% and therefore, the peak-to-peak center value was made coincident with the area center voltage Vdc shown in FIG. 4.

In the present embodiment, in order to control the developing property, these conditions are switched so that when the amount δ by which the PET sheet 11 shields the developing area α is increased, the percentage of the pulse waveform portion P may be made great to thereby achieve the up of the developing property, and when the amount δ by which the PET sheet 11 shields the developing area α is decreased, the percentage of the blank portion B may be made great to thereby achieve the down of the developing property.

Again in the present embodiment, a developing bias having this blank pulse bias superimposed thereon is applied to the developing roller 6 of the non-contact developing device 1a, whereby the exposed portion of the image bearing member 9 is developed. At this point of time, judgment as to whether the “sweeping-together” has occurred to the trailing end portion of the exposed portion of the image bearing member 9 wave visually effected. The evaluating method, as in Embodiment 1, was carried out with the developing apparatus la according to the present embodiment installed in the apparatus shown in FIG. 3.

First, in order to confirm the superiority of the non-contact developing apparatus la according to the present embodiment, evaluation was effected about a case where the switching of the blank pulse bias applied to the developing roller 6 is not effected in accordance with the amount δ by which the PET sheet 11 shields the developing area α.

The result of the above-described evaluation will now be described by the use of Table 3 below. Again in Table 3, by a method of expression similar to that in Tables 1 and 2, the signs given to numerical values shown in the row of free end location are such that with the closest portion “e” of the image bearing member 9 and the developing roller 6 in FIG. 2 as the reference, the upstream side with respect to the rotation direction of the developing roller 6 is represented by the negative, and the downstream side with respect to the rotation direction of the developing roller 6 is represented by the positive, and the numerical values represent the distance (mm) of the free end G from the closest portion “e” in + or − direction. That is, when the amount δ by which the PET sheet shields the developing area α is great, the numerical values in the row of free end location become positive, and when the amount δ by which the PET sheet shields the developing area α is small, the numerical values in the row of free end location below negative.

TABLE 3
Location of free end of PET sheet and Sweeping-together (without the switching of blank pulse)

| | location of free end (mm) | | | | | | | | | | | | |
|---|---|---|---|---|---|---|---|---|---|---|---|---|---|
| | +1.2 | +0.9 | +0.6 | +0.3 | reference | −0.3 | −0.6 | −0.9 | −1.2 | −1.5 | −1.6 | −1.7 | −1.8 |
| blank pulse | 10/10 | 10/10 | 10/10 | 10/10 | 10/10 | 10/10 | 10/10 | 10/10 | 10/10 | 10/10 | 10/10 | 10/10 | 10/10 |
| sweeping- | x | x | ∘ | ∘ | ∘ | ∘ | ∘ | ∘ | ∘ | ∘ | ∘ | Δ | Δ |
| together | | | | | | | | | | | | | |
| density | x | x | x | x | Δ | Δ | ∘ | ∘ | ∘ | ∘ | ∘ | ∘ | ∘ |
| | | | | | (streak) | (streak) | | | | | | | |

∘ . . . No problem.
Δ . . . No problem in practical use, yet each phenomenon can be confirmed.
x . . . Problematic in practical use.
(streak) . . . A region not developed like a blank longitudinal streak occurred

As will be seen from the result shown in Table 3, when the free end G of the PET sheet is at a location of −1.6 mm to +0.6 mm, the “sweeping-together” is improved to a problem-free level, and an improved effect was also seen in an area in which the free end G shallowly entered the developing area α.

On the other hand, when the free end G of the PET sheet 11 was at a location of −0.3 mm, a region not developed like a blank longitudinal streak appeared, and when the free end G was at a location of +0.3 mm or greater, developing density became apparently deficient.

That is, it has been found that the developing apparatus la according to the present embodiment using the blank pulse bias has the characteristic that for the ordinary AC rectangular wave bias used in Embodiment 1 of the present invention, the “sweeping-together” is restrained even in the area wherein the free end G of the PET sheet 11 more shallowly enters the developing area α, but when the free end G of the PET sheet 11 deeply enters the developing area α, developing density is difficult to obtain.

The evaluation when the switching of the blank pulse bias was carried out will now be likewise shown in Table 4 below.

TABLE 4
Location of free end of PET sheet and sweeping-together (with the switching of blank pulse)

| | location of free end (mm) | | | | | | | | | | | | |
|---|---|---|---|---|---|---|---|---|---|---|---|---|---|
| | +1.2 | +0.9 | +0.6 | +0.3 | reference | −0.3 | −0.6 | −0.9 | −1.2 | −1.5 | −1.6 | −1.7 | −1.8 |
| blank pulse | 8/4 | 8/4 | 8/4 | 12/8 | 12/8 | 10/10 | 10/10 | 10/10 | 10/10 | 8/12 | 8/12 | 7/13. | 10/20 |
| sweeping- | x | Δ | ∘ | ∘ | ∘ | ∘ | ∘ | ∘ | ∘ | ∘ | ∘ | ∘ | Δ |
| together | | | | | | | | | | | | | |
| density | x | Δ | ∘ | ∘ | ∘ | ∘ | ∘ | ∘ | ∘ | ∘ | ∘ | ∘ | ∘ |

∘ . . . No problem.
Δ . . . No problem in practical use, yet each phenomenon can be confirmed.
x . . . Problematic in practical use.

As will be seen from the result shown in Table 4, when the free end G of the PET sheet 11 is at a location of −1.6 mm to +0.6 mm, the “sweeping-together” is improved to a problem-free level, and an improved effect was also seen in an area wherein the free end G more shallowly entered the developing area α.

On the other hand, when the free end G of the PET sheet 11 was at a location of +0 .6 mm, a tendency toward low density appeared, and when the free end G was at a location of +0.9 mm or greater, the developing density became apparently deficient. However, when the switching of the blank pulse bias is not carried out, the developing density becomes deficient at a location of −0.3 mm or greater, whereas it is apparent that the mounted range of the PET sheet 11 becomes wide.

That is, a reduction in the developing density which was the evil of the use of the blank pulse bias described in connection with Table 3 was eliminated. As described above, the switching of the condition of the blank pulse bias applied to the developing roller 6 was effected in accordance with the amount δ by which the PET sheet 11 shields the developing area α, whereby a good quality of developed image could be obtained in a wider area, as compared with a case where the switching of the condition shown in Table 3 is not effected. It is preferable that the amount δ be stored in the image forming apparatus as information regarding the front edge location of the sheet 11, and it is preferable that the amount δ be stored in the apparatus or the cartridge by such a method as shown, for example, Embodiments 3 and 4 which will be described later.

While in the present embodiment, the blank pulse was used with the ratio thereof changed as 10/10BP, 12/8BP, 8/4BP, etc., the optimum blank pulse bias condition changes depending on various conditions such as the distance between the developing roller 6 and the image bearing member 9, and the outer diameters of the image bearing member 9 and the developing roller 6. Accordingly, an effect similar to that of the present invention can also be obtained in a case where an arbitrarily set blank pulse bias condition is switched while being correlated with the amount δ by which the PET sheet 11 shields the developing area α.

Embodiment 3

The non-contact developing devices 1 and la as the developing devices of the present invention as described in Embodiments 1 and 2 can be applied around the image bearing member 9 in all postures within a range in which the rotation directions of the image bearing member 9 and the developing roller 6 in the gaps d become the direction of gravity and therefore, are suitably applicable to image forming apparatuses of various constructions.

In the present embodiment, description will be made of an example of an image forming apparatus to which the present invention is applied.

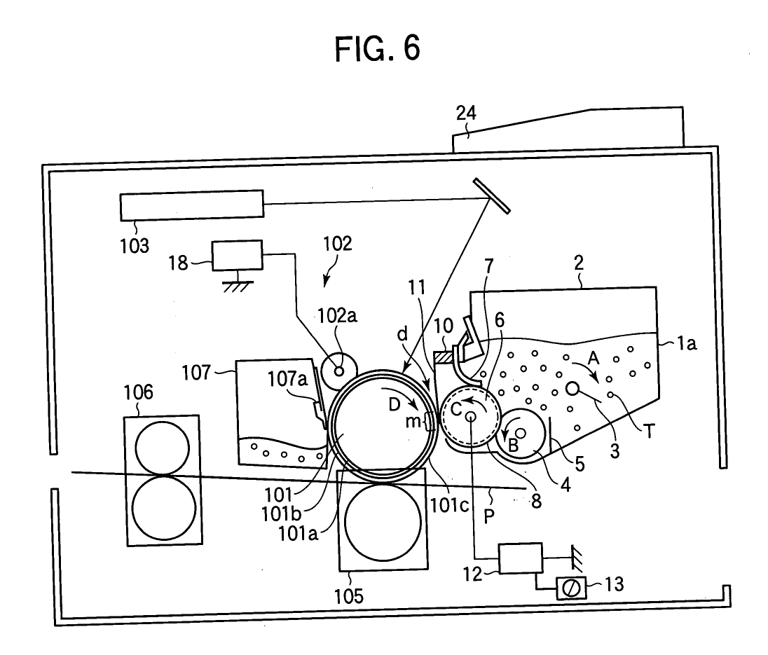

As shown in FIG. 6, the image forming apparatus according to the present embodiment is similar in basic construction to the image forming apparatus shown in FIG. 13 described in the conventional example, and adopts as the developing apparatus the non-contact developing device 1a described in Embodiment 2.

Again in the image forming apparatus according to the present embodiment shown in FIG. 6, an electrostatic latent image formed on a photosensitive drum 101 which is an image bearing member is developed by an oscillating voltage being applied to a developer carrying member 6 disposed at a predetermined gap from the photosensitive drum 101 to thereby form an oscillating electric field acting between the developer carrying member 6 and the photosensitive drum 101.

Also, the present embodiment is characterized in that a sheet member 11 formed of an insulating material is disposed so as to hang down from the upstream side with respect to the rotation direction of the developer carrying member 6 so as to enter a developing area α in a gap “d” formed by the developer carrying member 6 and the photosensitive drum 1, and when the developing apparatus 1a is to be interchanged, the condition of the applied oscillating voltage is controlled to an optimum value in accordance with the front edge location of the sheet member 11.

The image forming apparatus according to the present embodiment has as the image bearing member a photosensitive drum 101 formed with a diameter of 30 mm, and the photosensitive drum 101 is uniformly charged by a charging roller 102 as a contact charging member at a charging step. At a latent image forming step, the surface of the uniformly charged photosensitive drum 101 is exposed by a laser scanner (light source for exposure) 103 which is the exposing means of latent image forming means, whereby an electrostatic latent image is formed thereon, and at a developing step, the electrostatic latent image formed on the photosensitive drum 101 is developed by a non-contact developing device 1 as a developing apparatus containing a developer T therein.

The photosensitive drum 101 is a so-called organic photosensitive member comprising a substrate 101a formed of aluminum or the like, a charge generating layer 101b formed thereon, and a charge transporting layer 101c formed on the upper surface thereof.

The photosensitive drum 101 has its peripheral surface contact-charged to potential of −500 V by the charging roller 102 while being rotated in the direction indicated by the arrow D in FIG. 6.

An oscillating voltage comprising an AC voltage and a DC voltage superimposed one upon the other is applied from a charging power source 18 provided in an image forming apparatus main body to the substrate 102a of the charging roller 102 through a sliding electrode (not shown) brought into contact with the substrate 102a.

Then, scanning exposure by the laser scanner 103 is effected on the charged surface of the photosensitive drum 101, whereby an electrostatic latent image corresponding to desired image information is formed thereon.

In the non-contact developing device 1, the electrostatic latent image formed on the photosensitive drum 101 is developed by a developing bias acting between a developing roller 6 and a photosensitive drum 101 being applied to the developer carrying member (developing roller) 6 disposed at a predetermined gap from the photosensitive drum 101 and rotated in one direction.

On the other hand, when the electrostatic latent image borne on the photosensitive drum 101 arrives at a region opposed to the developing roller 6 carrying the developer T thereon, an oscillating voltage comprising an AC voltage and a DC voltage superimposed one upon the other is applied from a developing power source 12 to the developing roller 6 to thereby form an oscillating electric field between the photosensitive drum 101 and the developing roller 6, whereby the developer T flies and shifts to the electrostatic latent image formed on the surface of the photosensitive drum 101, and development is effected.

The developer image formed on the photosensitive drum 101 is transferred to a recording material P by the rotation of the photosensitive drum 101 in a transferring portion 105 provided in the image forming apparatus main body (the transferring step), and the recording material P is conveyed to a fixing portion 106, where the developer image is fixed (the fixing step), whereby a fixed image is completed on the recording material P.

On the other hand, a developer T residual on the photosensitive drum 101 during the transfer is scraped off by a cleaning blade 107a before it again passes the charging roller 102, and is accumulated in a waste developer container 107 (the cleaning step).

It is possible to install the developing apparatus 1 or 1a according to Embodiment 1 or 2 in the above-described image forming apparatus, and sweeping-together and a density reduction can be restrained in the formed image, but in the present embodiment, description will be made by the use of an example in which provision is made of the developing apparatus 1a of the construction described in Embodiment 2.

The construction of the developing device 1a is similar to that described with reference to FIG. 1, that is, as the image bearing member 9 described in Embodiment 1, the photosensitive drum 101 which is an image bearing member is provided in the image forming apparatus of the above-described construction, and the non-contact developing device, as described in Embodiment 1, develops the electrostatic latent image formed on the photosensitive drum 101 by an oscillating voltage acting between the photosensitive drum and the developing roller 6 disposed at a gap of 300 μm from the photosensitive drum 101 by regulating runners 8, and rotated in one direction being applied to the developing roller 6.

As in Embodiment 1 or 2, a PET sheet 11 having a thickness of about 60 μm is attached to a pedestal 10 fixed to the developing blade 7 so as to enter the developing area α in the gap “d” formed by the photosensitive drum 101 and the developing roller 6, and is disposed so as to hang down from the upstream side with respect to the rotation direction of the developing roller 6. At this time, adjustment was effected so that the PET sheet 11 might not contact with the developing roller 6.

In the present embodiment, the oscillating bias applied to the developing roller 6, as in the developing apparatus la according to Embodiment 2, is a blank pulse bias formed by a pulse waveform portion P in which potential changes alternately by an amount corresponding to ten waves, and a blank portion B in which potential does not change during a period similar to that in the pulse waveform portion P (an amount corresponding to ten waves), but becomes constant potential, as shown in FIG. 5.

Again here, the frequency of the pulse portion in which potential changes alternately was 3.0 kHz, the peak-to-peak voltage (amplitude) was 2.0 kV, the duty was 50%, and the peak-to-peak center value of the pulse waveform portion P was set to −300 V.

In order to control the developing property, the switching of this blank pulse bias was effected in accordance with the following two conditions as in Embodiment 2.

(1) When the amount δ by which the PET sheet 11 shields the developing area “m” increased, the percentage of the pulse waveform portion P was made great to thereby up the developing property.

(2) When the amount δ by which the PET sheet 11 shields the developing area “m” decreased, the percentage of the blank portion B was made great to thereby down the developing property.

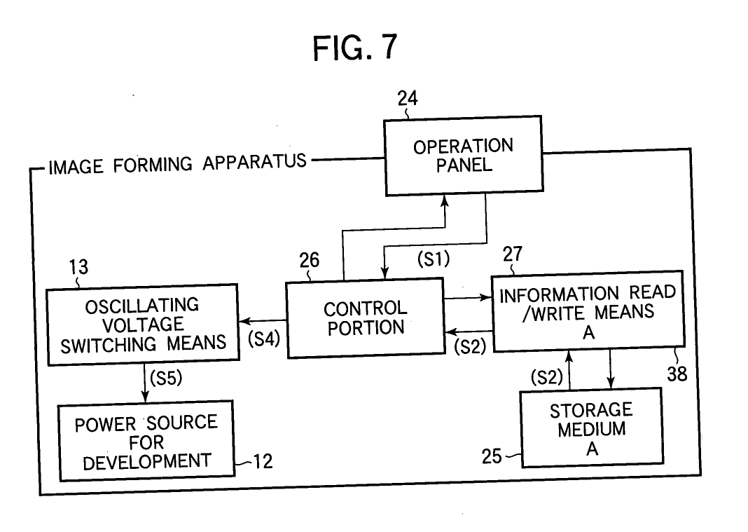

Here, in the present embodiment, the switching of the oscillating bias is effected while being controlled by the controlling means of the image forming apparatus of FIG. 6 shown in the block diagram of FIG. 7.

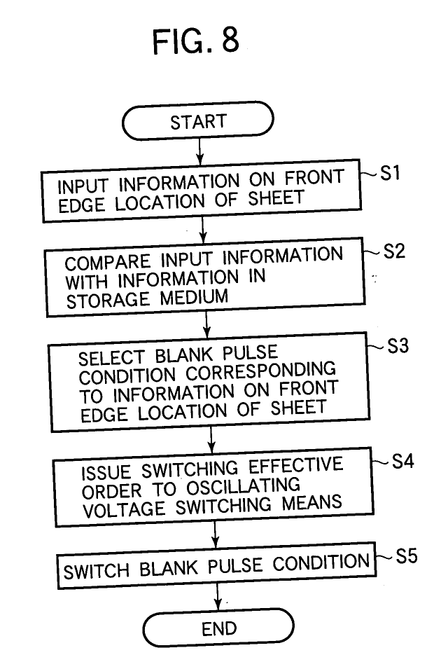

Means for effecting this switching of the oscillating bias will now be described with reference to the block diagram of FIG. 7 and the flow chart of FIG. 8.

Step S1: First, by an input from an operation panel 24 mounted on the outer packaging of the image forming apparatus shown in FIGS. 6 and 7 by the operator of the image forming apparatus, inputting is effected about the amount δ by which the PET sheet 11 shields the developing area “m” and which is definite in advance, i.e., the front edge location of the sheet 11. At this time, the front edge location information of the sheet 11 is what was obtained by effecting measurement during the shipment inspection of the developing device 1a by a laser measuring apparatus or the like, and differs from one developing device 1a installed to another. Also, the result of the aforedescribed measurement is attached to or stuck on each developing device 1a to be interchanged.

Step S2: On the other hand, a blank pulse condition (control table) corresponding to the front edge location of each sheet is stored in a storage medium A25. A control portion (controller) 26 effects the comparison between an inputted value and the information in the storage medium A25 connected thereto through information read/write means 27.

Step S3: On the basis of the comparing work at the step S2, the control portion 26 determines the blank pulse condition corresponding to the sheet position in the developing device 1.

Step S4: The control portion 26 which has determined a suitable blank pulse condition issues a switching execution order to oscillating voltage switching means 13 connected to a power source for development.

Step S5: The switching of the blank pulse condition is effected by the oscillating voltage switching means 13.

The control table of the controlling operation shown in the flow chart of FIG. 8 at the step S 2 is one in which the front edge location of the sheet and the suitable blank pulse condition are correlated with each other, as shown in Table 4 used for description in Embodiment 2 of the present invention.

Also, information regarding the blank pulse condition stored in the storage medium A25 enables rewriting and addition to be done by the operation panel 24. The operator can effect the correction of the control table in accordance with the situation of use to thereby effect the finer adjustment of the quality of image.

It is also possible to store a plurality of control tables in the storage medium A25, change the control tables depending on environmental conditions or the like and effect the switching of the blank pulse condition to thereby likewise effect the fine adjustment of the quality of image.

By using the above-described means, information concerning the front edge location of the sheet member stored in the storage medium can be arbitrarily changed in accordance with environmental conditions or the like under which the apparatus is used, and the bias applied to the developing roller and can be changed on the basis of this information to thereby obtain an optimum quality of output image under a wide condition.

The method of controlling the blank pulse bias, however, is not restricted to that described above.

Here, in order to confirm the superiority of the image forming apparatus according to the present embodiment, the position of the free end G of the PET sheet 11 was changed in the developing area α, and the situations of the “sweeping-together” and density on an output image were examined.

As the evaluating method, as in Embodiment 2, the blank pulse bias was changed, and the potential of the solid image portion latent image on the photosensitive drum 101 after exposure was effected by the laser scanner 103 was adjusted to −100 V to thereby provide a solid image portion of 25 mm×25 mm square on the output image, and evaluation was effected with attention paid to whether the “sweeping-together” occurred to the trailing end of this solid image portion.

As a result, there was obtained a result similar to that of the evaluation effected in Embodiment 2 of the present invention shown in Table 4.

Also, when the locations of the free end G of the PET sheet 11 were −1.7 mm and +0.6 mm and 2,000 sheets of image formation was continuously effected under the above-described conditions, the “sweeping-together” was restrained till the end of the evaluation in any one of these cases, and output images sufficient also in density were obtained.

Again in the image forming apparatus according to the present embodiment, the PET sheet was used as a sheet-like member mounted on the pedestal, use may also be made of any material such as, for example, urethane which has insulativeness and will not injure the photosensitive drum when it contacts with the latter, to obtain a similar effect.

Also, here, provision is made of the developing device 1a according to Embodiment 2 and the pedestal 10 is provided on the regulating member 7 of the developing device 1a, but for example, provision may be made of the frame member of the photosensitive drum and the pedestal 10 may be provided thereon and the PET sheet 11 may be disposed there, and the pedestal can be provided somewhere in the image forming apparatus.

The width of the PET sheet is designed to cover all of the area (developing width) in which the developing roller carries the developer T, and not to extend beyond the regulating runners provided on the opposite end portions of the developing roller, whereby the “sweeping-together” and the scattering of the developer can be restrained over the entire developing width area.

Also, if as in the image forming apparatus according to the present embodiment, the PET sheet is disposed in the gap between the photosensitive drum and the developing roller so as to hang down there, it will also be possible to restrain the “sweeping-together” in a multi-color image forming apparatus of the tandem type, the rotary type or the like which houses a plurality of developing devices therein and effects the formation of a full-color image by layering developer images resulting from development effected by the respective developing devices.

The developing device 1 according to Embodiment 1 may be provided in the image forming apparatus according to the present embodiment, and the duty of the oscillating bias in the developing bias may be changed as in Table 1 to thereby obtain a result similar to that of Embodiment 1.

That is, the effect in the developing apparatuses described in Embodiments 1 and 2 could also be obtained in the image forming apparatus.

Besides the construction shown in FIG. 6, various constructions can be applied to the image forming apparatus.

Embodiment 4

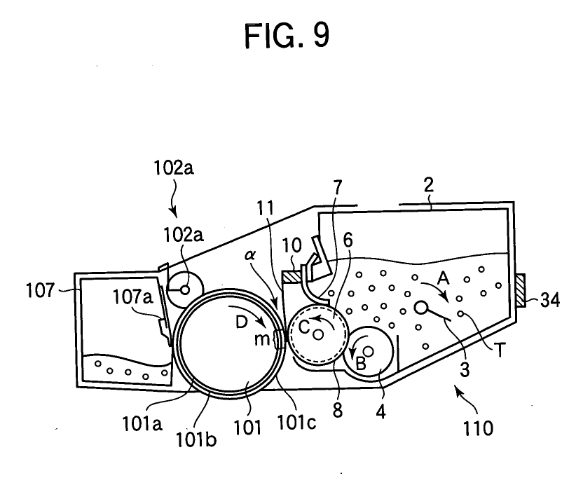

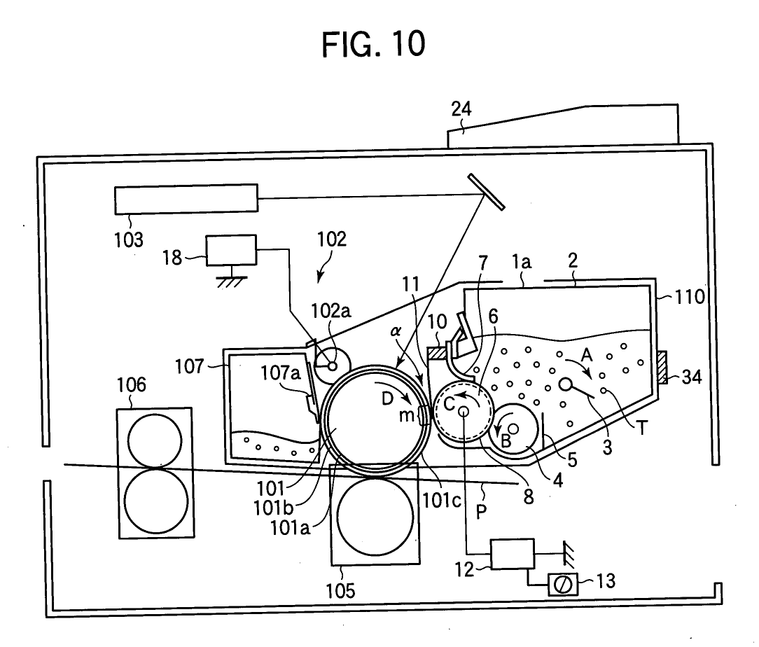

FIG. 9 shows a typical view of a cartridge 110 in the present embodiment, and FIG. 10 shows a typical view of an image forming apparatus mounting this cartridge 110 therein to thereby effect image formation.

The cartridge 110 in the present embodiment is such that of the constituents of the image forming process in the image forming apparatus of a construction shown in FIG. 10 which carries out image formation similar to that by the image forming apparatus of FIG. 6 used in Embodiment 3 of the present invention, a photosensitive drum 101 which is an image bearing member, a charging roller 102 which is charging means for charging the surface of the photosensitive drum 101, a developing device 1a for non-contact-developing an electrostatic latent image formed on the photosensitive drum 101, a cleaning blade 107a and a waste developer containing portion 107 are integrally made into a process cartridge 110 detachably mountable on an image forming apparatus main body. In the other points, the construction of the image forming apparatus according to the present embodiment is similar to that described in Embodiment 3 and therefore need not be described. The process cartridge is a cartridge obtained by an image bearing member such as a photosensitive drum and image forming means acting thereon being made integral with each other, and made detachably mountable with respect to an image forming apparatus.

As the developing apparatus, provision is made of a developing device la in which, as in Embodiment 2, a blank pulse bias is superimposed as a developing bias, and the blank pulse bias is switched. Here, as in Embodiment 1, provision can be made of a developing device 1 in which the duty in the AC component of the developing bias can be switched.

Further, a PET sheet 11 shielding the developing area α in the gap “d” between the photosensitive drum 101 and a developing roller 6 is also mounted in the process cartridge 110 through a pedestal 10.

A storage medium B34 is carried on the process cartridge 110, and information concerning the front edge location of the PET sheet 11 is written therein.

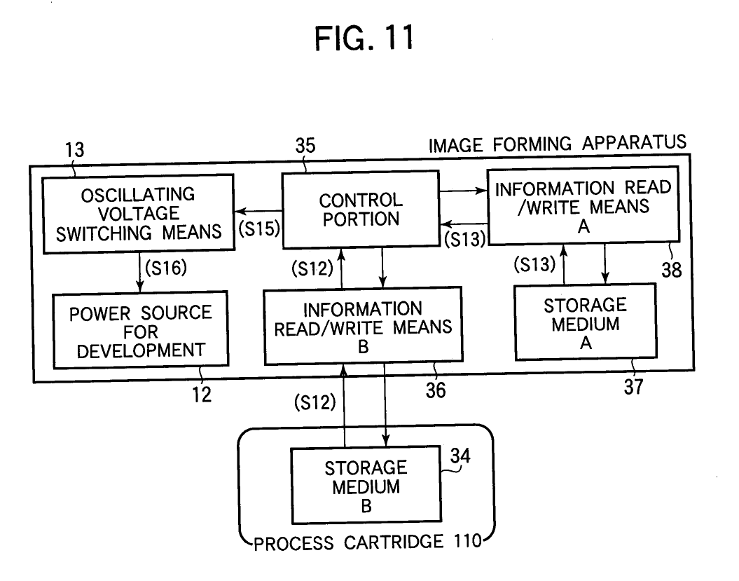

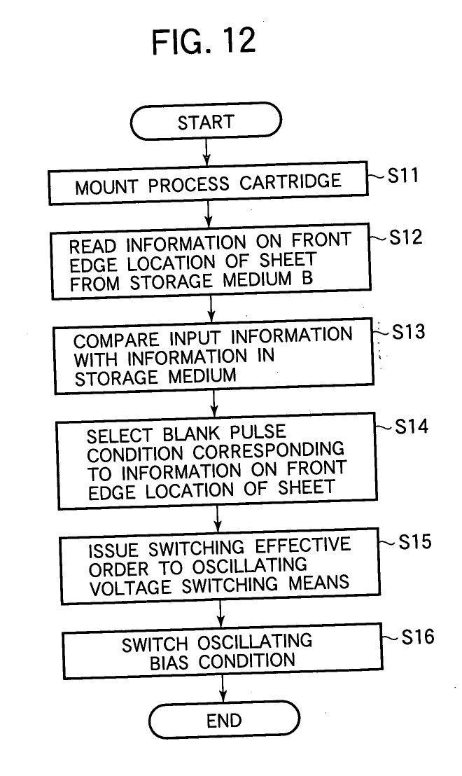

Again here, the blank pulse bias is switched in the same manner as that described in Embodiment 2 by the controlling means of the image forming apparatus shown in the block diagram of FIG. 11. Oscillating bias switching means in the present embodiment will now be described with reference to the block diagram of FIG. 11 and the flow chart of FIG. 12.

Step S11: The process cartridge 110 is mounted on an image forming apparatus main body.

Step S12: Thereupon, a control portion (controller) 35 reads information concerning the front edge location of the PET sheet 11 from the storage medium B34 carried on the process cartridge 110 through information read/write means B36. The sheet front edge location information stored in the storage medium 34 carried on the process cartridge 110 is that obtained by effecting measurement during shipment inspection by a laser measuring apparatus or the like, and differs from one process cartridge 110 to another.

Step S13: On the other hand, a blank pulse condition (control table) corresponding to the front edge location of each sheet is stored in a storage medium A37 on the image forming apparatus side. The Control portion 35 effects comparison between the information from the storage medium B34 obtained at the step S12 and the information in the storage medium A37 connected through information read/write means A38.

Step S14: A corresponding oscillating bias condition is determined in the comparing work by the control portion 35 at the step S13.

Step S15: The control portion 35 issues a switching execution order to oscillating voltage switching means 13 connected to a power source 12 for development.

Step S16: The switching of the oscillating bias condition applied to the developing roller 6 is effected.

Again in the image forming apparatus according to the present embodiment, as in the image forming apparatus which is Embodiment 3 of the present invention, the “sweeping-together” and a density reduction in output images could be restrained.

Also, in the present embodiment, each time the process cartridge is interchanged, it is unnecessary for the operator to set the front edge location of the sheet from the operation panel or the like, and the oscillating bias condition can be reliably switched to an optimum oscillating condition in accordance with the state of each process cartridge and therefore, it becomes possible to restrain the unevenness of the quality of image among the plurality of process cartridges.

Further, the interchange of consumables such as the photosensitive drum and the charging roller and the supply of the developer can be effected easily by only the simple operation of interchanging the process cartridge and therefore, the labor of a user concerned in various kinds of maintenance work can be mitigated, and stable output images became obtainable for a long period of time.

It also becomes possible to alleviate the mounting accuracy of the sheet-like member during manufacture, and the above-noted merits can be provided relatively inexpensively.

Also, not as a process cartridge like the present embodiment, only the developing apparatus may be made into a cartridge and the storage medium B34 may be provided in the developing apparatus.

Also, here, provision is made of the developing device 1a according to Embodiment 2, and the pedestal 10 is provided on the regulating member 7 of the developing device 1a, but for example, provision may be made of the frame member of the photosensitive drum and the pedestal 10 may be provided there, and the PET sheet 11 may be disposed, and can be provided somewhere in the image forming apparatus or the cartridge 110.

By using the above-described means, it becomes possible to control the oscillating voltage to an optimum value in each cartridge on the basis of the information concerning the front edge location of the sheet-like member stored in the storage medium of the cartridge. Accordingly, the “sweeping-together” is effectively restrained and output images of high dignity become obtainable for a long period of time.

While in the foregoing embodiments the sheet member as the flight developer regulating member is an insulative member, electrically it can be a floating electrically conductive member.

This application claims priority from Japanese Patent Application No. 2004-177546 filed Jun. 15, 2004, which is hereby incorporated by reference herein.

1. An image forming apparatus comprising:
a developer carrying member for developing an electrostatic image formed on an image bearing member with a developer; and
a flight developer regulating member provided between said image bearing member and said developer carrying member for regulating an area in which the developer flies from said developer carrying member to said image bearing member,
wherein a voltage applied to said developer carrying member is controlled in accordance with information regarding a front edge location of said flight developer regulating member.

2. An image forming apparatus according to claim 1, wherein said voltage is an oscillating voltage, and is applied to said developer carrying member during a developing operation of effecting development on said image bearing member by said developer carrying member.

3. An image forming apparatus according to claim 2, wherein by said oscillating voltage being applied to said developer carrying member, an alternating electric field is formed between said image bearing member and said developer carrying member.

4. An image forming apparatus according to claim 2, wherein a duty of said oscillating voltage is controlled in accordance with said information.

5. An image forming apparatus according to claim 2, wherein said oscillating voltage alternately forms a portion forming an oscillating electric field between said image bearing member and said developer carrying member, and a portion not forming an oscillating electric field between said image bearing member and said developer carrying member.

6. An image forming apparatus according to claim 5, wherein a ratio of said portion forming said oscillating electric field to said portion not forming said oscillating electric field is controlled in accordance with said information.

7. An image forming apparatus according to claim 1, wherein said flight developer regulating member is a sheet member.

8. An image forming apparatus according to claim 7, wherein said front edge location of said flight developer regulating member is below, in a vertical direction, a location at which said flight developer regulating member is supported.

9. An image forming apparatus according to claim 1, further comprising a controller for controlling said voltage in accordance with said information.

10. An image forming apparatus according to claim 1, wherein said flight developer regulating member is provided in contact with said image bearing member.

11. An image forming apparatus according to claim 1, wherein said flight developer regulating member is provided in spaced-apart relationship with the developer carried on said developer carrying member.

12. An image forming apparatus according to claim 1, wherein said flight developer regulating member is an insulative member.

13. A cartridge detachably mountable to a main body of an image forming apparatus, said cartridge comprising:
a developer carrying member for developing an electrostatic image formed on an image bearing member with a developer;
a flight developer regulating member provided between said image bearing member and said developer carrying member for regulating an area in which the developer flies from said developer carrying member to said image bearing member; and
a storage medium for storing information regarding a front edge location of said flight developer regulating member.

14. A cartridge according to claim 13, wherein said main body of said image forming apparatus controls, in accordance with said information, a voltage applied to said developer carrying member.

15. A cartridge according to claim 13, wherein said flight developer regulating member is a sheet member.

16. A cartridge according to claim 15, wherein said front edge location of said flight developer regulating member is below, in a vertical direction, a location at which said flight developer regulating member is supported.

17. A cartridge according to claim 13, wherein said flight developer regulating member is provided in contact with said image bearing member.

18. A cartridge according to claim 13, wherein said flight developer regulating member is provided in spaced-apart relationship with the developer carried on said developer carrying member.

19. A cartridge according to claim 13, wherein said flight developer regulating member is an insulative member.

20. A cartridge according to claim 13, further comprising said image bearing member.
